(19) United States
(12) Patent Application Publication
(10) Pub. No.: US 2009/0054147 A1
(43) Pub. Date: Feb. 26, 2009

(54) INTERACTIVE GAME SYSTEM

(75) Inventors: Shuo-Tsung Chiu, Taipei Hsien (TW); Wen-Cheng Hsu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/842,495

(22) Filed: Aug. 21, 2007

(51) Int. Cl. G06F 17/00

(52) U.S. Cl. 463/39

(57) ABSTRACT

An interactive game system has a main apparatus and a wireless controller. The main apparatus has three ultrasonic receiving modules. The wireless controller has an ultrasonic sending module. The three ultrasonic receiving modules receive ultrasonic signals sent by the ultrasonic sending module, and the main apparatus calculates the position of the wireless controller. When the wireless controller is moved, the main apparatus obtains a plurality of coordinate values indicating the motion track of the wireless controller. In this case, an electronic device shows the movement of the wireless controller on a display device by monitoring the coordinate values.

### BACKGROUND OF THE INVENTION

1. Field of the Invention

This present invention relates to an interactive game system, and more specifically to an interactive game system having a main apparatus to ascertain a wireless controller by ultrasonic wave.

2. The Related Art

Nowadays, more and more people are amused by varieties of video games or computer games. Taking a computer game for example, conventionally, if a player wants to play the computer game, he firstly has to install game software in a host of a computer. The player controls the game process by peripherals of the computer, such as a mouse, a keyboard, a control handle or the like, all of which connect with the host. The gaming information is displayed to the player through a monitor, a speaker or in combination of different multimedia output devices.

One example of the interactive gaming devices disclosed in U.S. patent public No. 2007/0072674 which is issued Jan. 2, 2006 includes a host apparatus connected to a TV receiver via a connection cord, a wireless controller for giving operation data to the host apparatus, and a pair of infrared markers provided on the TV receiver. Each of infrared markers outputs infrared light forward. The host apparatus is connected to a receiving unit via a connection terminal. The receiving unit is used for receiving operation data that is wirelessly transmitted from the wireless controller.

The wireless controller includes an operation section, an imaging information calculation section, a communication section and an acceleration sensor. The operation section includes a plurality of operation buttons set on the wireless controller in order to direct the game process controlled by the player. The imaging information calculation section includes an infrared filter, a lens, an imaging element and an image processing circuit. The infrared filter allows only infrared light to pass therethrough. The lens collects the infrared light which has passed through the infrared filter and outputs the infrared light to the imaging element. The imaging element is a solid-state imaging device, such as a CMOS sensor or a CCD. The imaging element takes an image of the infrared light which has passed through the infrared filter and been collected by the lens, and generates image data. The image data is processed by the image processing circuit. The image processing circuit calculates the positions of the infrared markers in the taken image, and outputs coordinate sets to the communication section.

The acceleration sensor detects acceleration in three axial directions of the wireless controller, i.e., the up-down direction, the left-right direction and the front-rear direction. The acceleration sensor allows the inclinations of the wireless controller in the three axial directions to be determined. In addition to the taken image mentioned above, the wireless control determines the acceleration and inclination thereof via the acceleration sensor.

The communication section includes a microcomputer, a memory, a wireless module and an antenna. The microcomputer receives the data which is output from the operation section, the acceleration sensor, and the imaging information calculation circuit and stores the data in the memory. The wireless module and the antenna transmit the data stored in the memory to the host apparatus by a wireless technology. The data includes the displacement direction, the inclination and the acceleration of the wireless controller.

The host apparatus uses the receiving unit to receive the operation data from the wireless controller in a way of wireless transmission and executes the game process based on the obtained operation data.

The imaging information calculation section collects and calculates positions of the two infrared markers. After acquiring determined positions, the interactive gaming device accompanies data from the acceleration sensor to further discover the inclination and the acceleration of the wireless controller. Then, the communication section transmits the data of the displacement direction, the inclination and the acceleration of the wireless controller to the host apparatus to be processed. It can be seen that the interactive gaming device should provide the imaging information calculation section and the acceleration sensor to position the wireless controller. So the manufacture cost of the interactive gaming device is increased. Further more, if the environment around the infrared markers brings infrared interference, the imaging information calculation section will not attain the positions of the two infrared markers exactly. Therefore, the game can't go on.

Hence, an improved interactive gaming device is desired to overcome the shortcomings described above.

### SUMMARY OF THE INVENTION

Accordingly, an object of the present invention is to provide an interactive game system. The interactive game system includes a main apparatus and a wireless controller. The main apparatus includes three ultrasonic receiving modules, a first memory unit, a first wireless communication module, a USB module and a first microprocessor. The first memory module stores the data while the first microprocessor is operating. The ultrasonic receiving modules receive the ultrasonic signals sent by the wireless controller and convert the ultrasonic signals into detecting signals, the first microprocessor processes the detecting signals and concludes the position of the wireless controller. The first wireless communication module delivers the controlling signals and data between the main apparatus and the wireless controller. The USB module transmits data and controlling signal between the main apparatus and an outer electronic device.

The wireless controller includes a second microprocessor, a monitoring circuit, a second memory module, an ultrasonic sending module, a second wireless communication module and a charging module. The second microprocessor connects the monitoring circuit, the second memory module, the ultrasonic module and the second wireless communication module. The monitoring circuit connects the charging module. The second memory module stores the data while the second microprocessor is operating. The ultrasonic sending module sends ultrasonic signals into the main apparatus. The second wireless communication module transmits controlling signals and data between the wireless controller and the main apparatus according to the first wireless communication module. The charging module is used to store power and affords the power to the wireless controller. The monitoring circuit is used to detect the state of the charging module.

The structure of the interactive game device is simplified, so the manufacture cost is reduced. Moreover, the ultrasonic is uneasy to be interfered, so the wireless controller is positioned more precisely. Therefore, the invention attains the aim of overcoming the drawbacks of the prior art.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of an interactive game system, which is connected to a host of a computer and a display device in accordance with the present invention;

FIG. 2 is a circuit block diagram of a main apparatus of the interactive game system according to a first embodiment;

FIG. 3 is a circuit block diagram of an ultrasonic receiving module of the main apparatus;

FIG. 4 shows a circuit block diagram of a main apparatus of the interactive game system according to a second embodiment;

FIG. 5 is a circuit block diagram of a first communication module of the interactive game system;

FIG. 6 shows a circuit block diagram of a wireless controller of the interactive game system according to the first embodiment;

FIG. 7 shows a circuit block diagram of an ultrasonic sending module of the interactive game system;

FIG. 8 is a circuit block diagram of a second communication module of the interactive game system;

FIG. 9 is circuit block diagram of an audio outputting module of the interactive game system;

FIG. 10 shows a circuit block diagram of a charging module according to the interactive game system; and

FIG. 11 shows a circuit block diagram of the wireless controller of the interactive game system according to the second embodiment.

### DETAILED DESCRIPTION OF THE PREFERRED EMBODIMENT

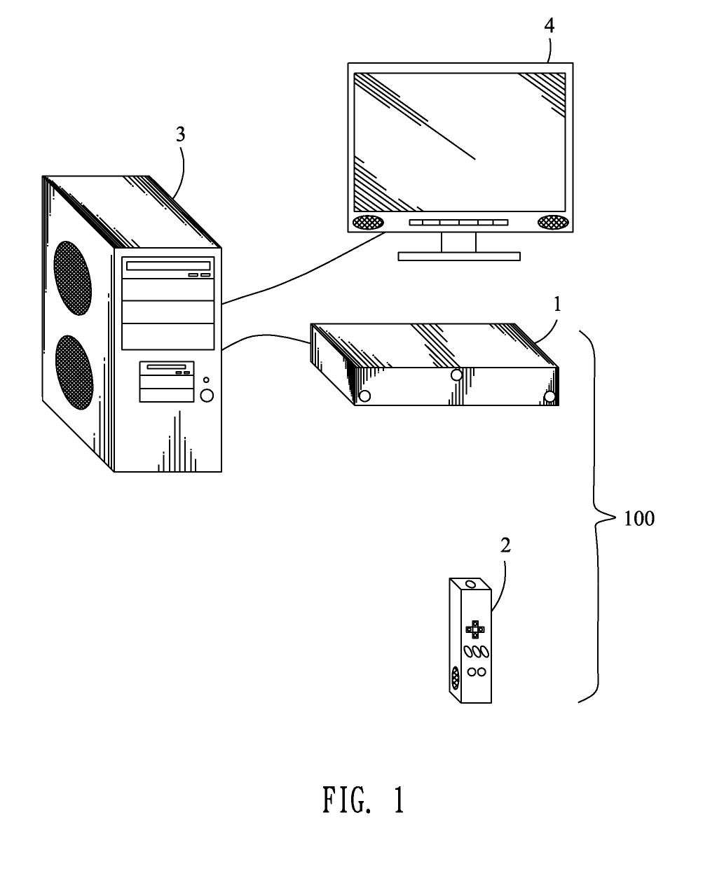

With reference to FIG. 1, an interactive game device 100 in accordance with the present invention includes a main apparatus 1 and a wireless controller 2. The main apparatus 1 connects an electronic device such as a host of a computer or a gaming device via a cable. In this embodiment, the electronic device is a host 3 of a computer. The host 3 further connects a monitor 4 such as a display device. Game software is installed in the host 3, and when a player has a game, the player can control the game process by the wireless controller 2. The main apparatus 1 receives the control signals from the wireless controller 2 and calculates the coordinate values of the wireless controller 2 in space. The main apparatus 1 transmits the control signals and the coordinate values to the game software installed in the host 3 by the cable. The game software further controls the game process based on the control signals and the coordinate values of the wireless controller 2, and shows the game process to the player through the monitor 4.

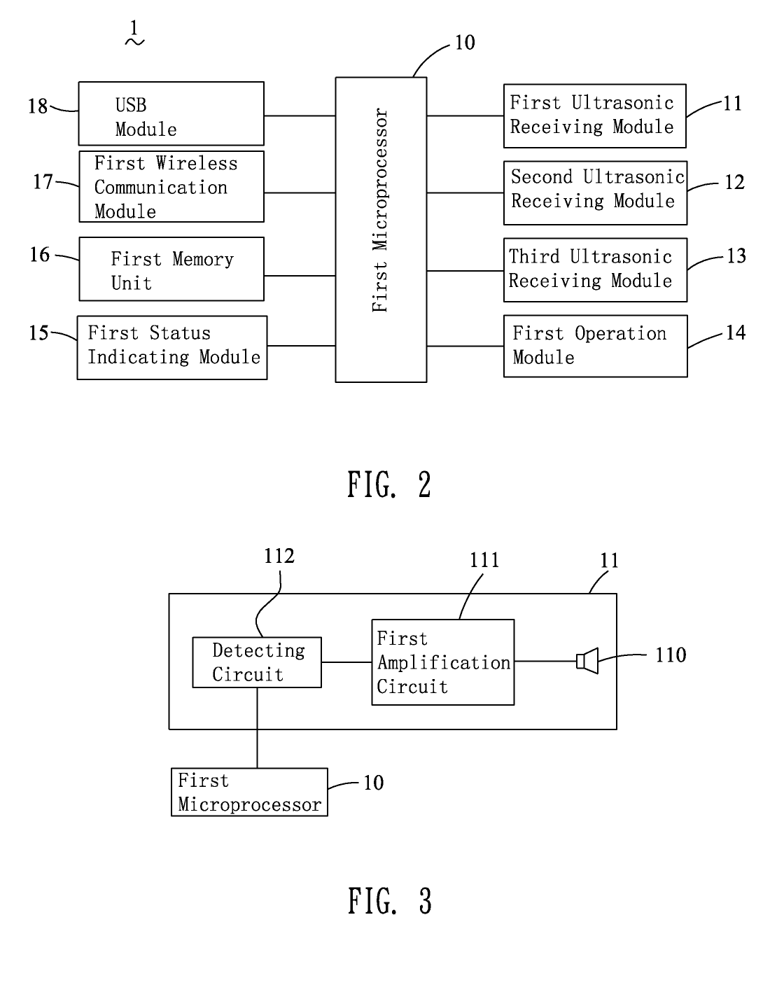

Please refer to FIG. 2 is a circuit block diagram of a first embodiment of the main apparatus 1. The main apparatus 1 includes a first microcomputer 10, a first ultrasonic receiving module 11, a second ultrasonic receiving module 12, a third ultrasonic receiving module 13, a first operation module 14, a first status indicating module 15, a first memory unit 16, a first wireless communication module 17 and a USB module 18. The first ultrasonic receiving module 11, the second ultrasonic receiving module 12 and the third ultrasonic receiving module 13 respectively connect the first microprocessor 10. The first ultrasonic receiving module 11, the second ultrasonic receiving module 12 and the third ultrasonic receiving module 13 can receive ultrasonic signals from the wireless controller 2, and convert ultrasonic signals into detecting signals and then deliver the detecting signals to the first microprocessor 10.

The first operation module 14 connects the first microprocessor 10, the player controls the first operation module 14 and make lots of controlling signals, the first microprocessor 10 detects the controlling signals and then controls the main apparatus 1. In this embodiment, the first operation module 14 has a power switch, a rearranging key and a linking key, etc. When the player presses the power switch, the main apparatus 1 start to operate, the main apparatus 1 stops while the power switch was pressed by the player. When the main apparatus 1 is operating, the rearranging key was pressed, the main apparatus 1 returns to the start state. While the linking key was pressed, a neighbor wireless controller can together operate with the wireless controller 2 in the interactive game system 100.

The first status indicating module 15 connects with the first microprocessor 10, the first microprocessor 10 delivers controlling signals according to the state of the main apparatus 1 to the first status indicating module 15, the first status indicating module 15 displays lots of notations according to the controlling signals, so the player can know the state of the main apparatus 1. In this embodiment, the first status indicating module 15 has an LED controller and lots of LED. The first microprocessor 10 delivers controlling signals according to the present state of the main apparatus 1 to the LED controller, the LED controller controls the LED lighting according to the controlling signals, so the player can know the state of the main apparatus 1.

The first memory unit 16 connects with the first microprocessor 10 and store the initial information that the first microprocessor 10 need to load while the main apparatus 1 is turned on. When the main apparatus 1 connects to the power, the first microprocessor 10 reads the initial information stored in the first memory unit 16, then the main apparatus 1 can operate. The first microprocessor 10 can also store any important information in the first memory unit 16.

The first wireless communication module 17 connects the first microprocessor 10 and receives controlling signals from the first microprocessor 10, then the first wireless communication module 17 encodes the controlling signals into wireless signals and send out the wireless signals. The first wireless communication module 17 can receive wireless signals, and decode controlling signals to controlling signals, then deliver the controlling signals to the first microprocessor 10. The USB module 18 connects the first microprocessor 10, the USB module 18 and a USB wire in the host 3 connect the main apparatus 1 with the host 3, so data can be transmitted between the host 3 and the main apparatus 1. And the host 3 can afford energy to the main apparatus 1 via the USB module 18.

With reference to FIG. 3, in this embodiment, the three ultrasonic receiving modules 11, 12, 13 have same circuits, such as the first ultrasonic receiving module 11 has an ultrasonic receiving apparatus 110, a first amplification circuit 111 and a detecting circuit 112, the ultrasonic receiving apparatus 110 connects the first amplification circuit 111, the detecting circuit 112 connects the first amplification circuit 111 with the first microprocessor 10.

The ultrasonic receiving apparatus 110 can receive ultrasonic signals and deliver the ultrasonic signals to the first amplification circuit 111, the first amplification circuit 111 amplifies the ultrasonic signals to afford to the detecting circuit 112, the detecting circuit 112 processes the amplified ultrasonic signals and then delivers the amplified ultrasonic signals which have been processed into the first microprocessor 10.

For example, the frequency of the ultrasonic signal is 40 KHZ, the detecting circuit 112 receives the 40 KHZ signal and converts the signal into a high preset value detecting signal, then the detecting signal is delivered to the first microprocessor 10. While the detecting circuit 112 receives a signal, the frequency of which is not 40 KHZ, the detecting circuit 112 converts the signal into a lower preset value detecting signal and delivers the detecting signal to the first microprocessor 10.

Please refer to FIG. 2 again, the first microprocessor 10 detects detecting signals from the three ultrasonic receiving module 11, 12 and 13 by a polling mode. In this embodiment, while the first microprocessor 10 detects a high preset value detecting signal from the three ultrasonic receiving modules 11, 12 and 13, the first microprocessor 10 calculates the time between a former detecting signal and a present detecting signal to produces a coordinates about the wireless controller 2.

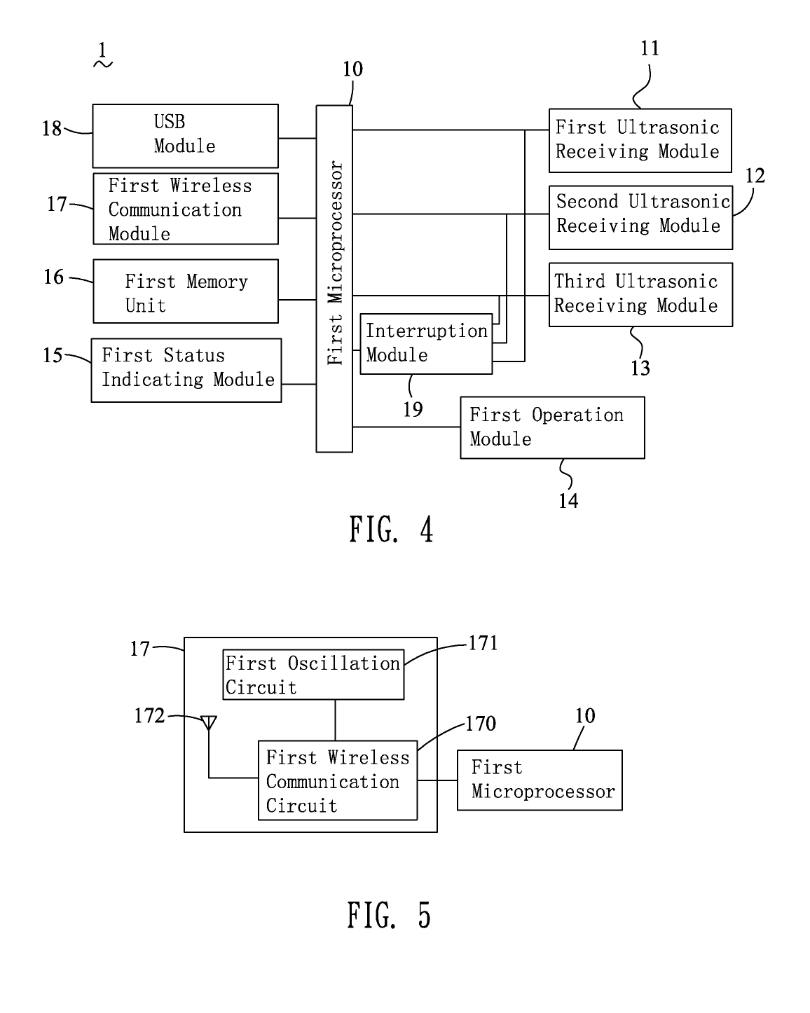

Refer to FIG. 4, which is a circuit block diagram of a second embodiment of the main apparatus 1. The main apparatus 1 further comprises an interruption module 19, the interruption module 19 connects the three ultrasonic receiving modules 11, 12 and 13 and the first microprocessor 10. The interruption module 19 receives detecting signals from the three ultrasonic receiving modules 11, 12 and 13, and produces an interrupter signal according to the detecting signals, then delivers the interrupter signal to the first microprocessor 10.

In this embodiment, while the detecting signal is a high preset value detecting signal from the three ultrasonic receiving modules 11, 12 and 13, the interruption module 19 generates an interrupter signal and delivers the interrupter signal to the first microprocessor 10. When the first microprocessor 10 receives the interrupter signal from the interruption module 19, the first microprocessor 10 calculates the time between the former signal and the present signal to generate a coordinates about the wireless controller 2.

Please refer to FIG. 5, the first wireless communication module 17 has a first wireless communication circuit 170, a first oscillation circuit 171 and a first antenna 172. The first oscillation circuit 171 connects the first wireless communication circuit 170 to deliver a signal to the first wireless communication circuit 170. The first wireless communication circuit 170 connects the first microprocessor 10 and the first antenna 172.

The first wireless communication circuit 170 can be switched to a receiving state or a sending state. While the first wireless communication circuit 170 is in sending state, the first wireless communication module 17 receives a controlling signal from the first microprocessor 10, and encodes the controlling signal, then the controlling signal encoded is sent out by the first antenna 172. When the first wireless communication circuit 170 is in receiving state, the first antenna 172 receives a wireless signal, the first wireless communication circuit 170 decodes the signal, and then delivers the signal decoded to the first microprocessor 10.

In this embodiment, the main apparatus 1 receives data from the host 3 via the USB module 18, the data may be sound data, and the data is delivered to the first microprocessor 10 via the USB module 18. The first microprocessor 10 delivers the data to the first wireless communication module 17, and then the first wireless communication module 17 converts the data into wireless signal and delivers the wireless signal to the wireless controller 2.

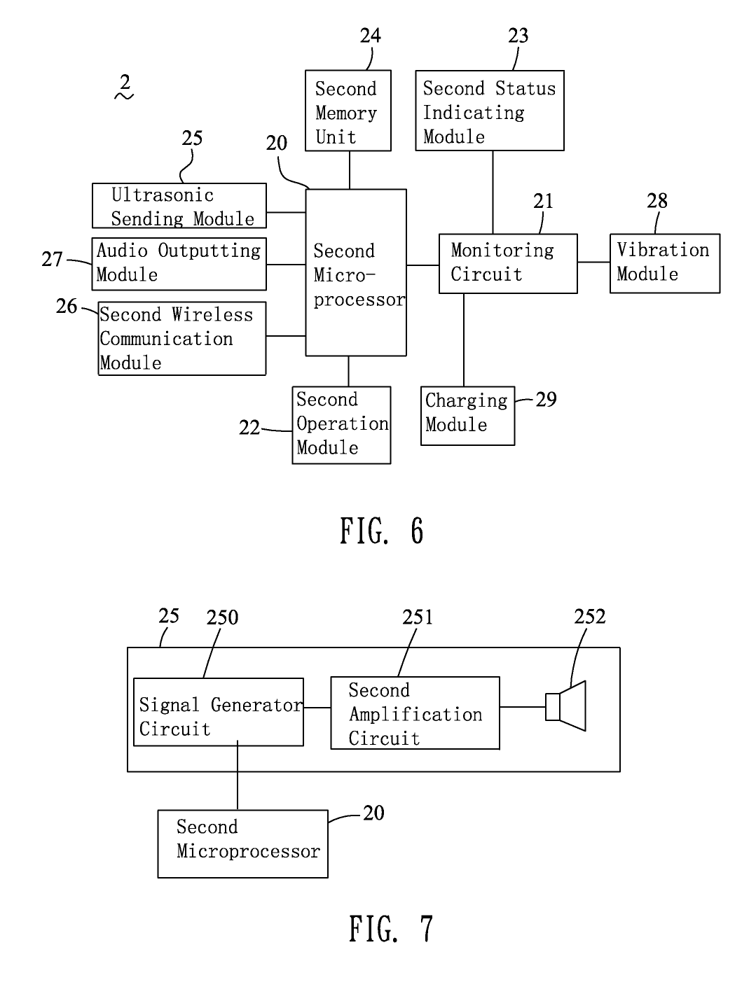

Referring to FIG. 6, the wireless controller 2 has a second microprocessor 20, a monitoring circuit 21, a second operation module 22, a second status indicating module 23, a second memory unit 24, an ultrasonic sending module 25, a second wireless communication module 26, an audio outputting module 27, a vibration module 28 and a charging module 29. The second microprocessor 20 connects the monitoring circuit 21, the second operation module 22, the second memory unit 24, the ultrasonic sending module 25, the second wireless communication module 26 and the audio outputting module 27. The monitoring circuit 21 connects the second status indicating module 23, the vibration module 28 and the charging module 29.

The second microprocessor 20 sends controlling signal to the monitoring circuit 21, the monitoring circuit 21 controls the second status indicating module 23 and the vibration module 28 according to the controlling signal, and the monitoring circuit 21 detects the state of the charging module 29. A plurality of keys are arranged on the second operation module 22, while the game is processing, the player can control the game by pressing the keys. The second microprocessor 20 detects the pressure state of the keys of the second operation module 22 and generates different controlling signals according to the pressure state.

The second microprocessor 20 delivers controlling signals to the second status indicating module 23 by the monitoring circuit 21 according to the present state of the wireless controller 2, the second status indicating module 23 generates lots of recognizing symbols according to the controlling signals, so the player can know and control the state of the wireless controller 2. In this embodiment, the second status indicating module 23 has an LED controller and lots of LED. The second microprocessor 20 delivers controlling signals according to the present state of the wireless controller 2 to the LED controller, the LED controller controls the LED lighting according to the controlling signals, so the player can know the state of the wireless controller 2.

The second memory unit 24 connects with the second microprocessor 20 to store the initial information that the second microprocessor 2 need to load while the wireless apparatus 2 is turned on. When the wireless apparatus 2 connects to the power, the second microprocessor 20 reads the initial information stored in the second memory unit 24, then the wireless apparatus 2 can operate. The first microprocessor can also store any important information in the second memory unit 24.

Please refer to FIG. 7, the ultrasonic sending module 25 has a signal generator circuit 250, a second amplification circuit 251 and an ultrasonic sending apparatus 252. The signal generator circuit 250 connects the second microprocessor 20 and the second amplification circuit 251, the second amplification circuit 251 connects the ultrasonic sending apparatus 252. The second microprocessor 20 can control the signal generator circuit 250 to generate an ultrasonic signal. The second amplification circuit 251 receives the ultrasonic signal from the signal generator circuit 250 and magnifies the ultrasonic signal, then the ultrasonic signal magnified is delivered to the ultrasonic sending apparatus 252, the ultrasonic sending apparatus 252 sends out the ultrasonic signal.

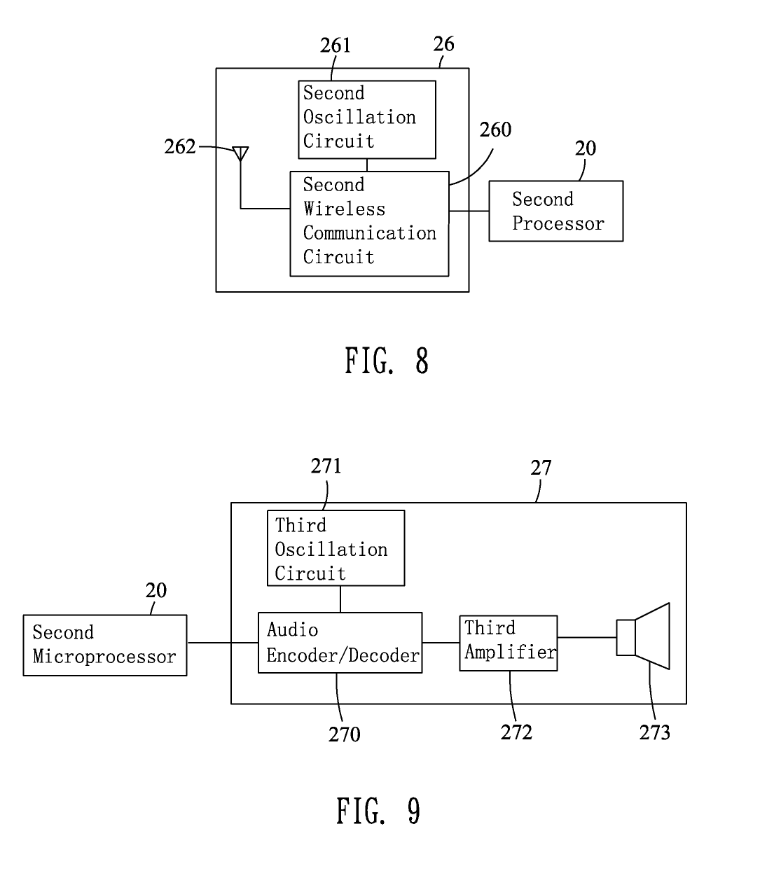

Referring to FIG. 8, the second wireless communication module 26 has a second wireless communication circuit 260, a second oscillation circuit 261 and a second antenna 262. The second oscillation circuit 261 connects the second communication circuit 260 and provides a signal to the second communication circuit 260. The second communication circuit 260 connects the second microprocessor 20 and a second antenna 262.

The second wireless communication circuit 260 can be switched to a receiving state or a sending state. While the second wireless communication circuit 260 is in sending state, the second wireless communication module 26 receives a controlling signal from the second microprocessor 20, and encodes the controlling signal, then the controlling signal encoded is sent out by the second antenna 262. When the second wireless communication circuit 260 is in receiving state, the second antenna 262 receives a wireless signal, the second wireless communication circuit 260 decodes the signal, and then delivers the signal decoded to the second microprocessor 20. The wireless signal includes a controlling signal and a sound data.

In FIG. 9, the audio outputting module 27 has an audio encoder/decoder 270, a third oscillation circuit 271, a third amplifier 272 and a sounding device 273. The audio encoder/decoder 270 connects the second microprocessor 20, the third oscillation circuit 271, the third amplifier 272 respectively. The third amplifier 272 connects the sounding device 273.

The second microprocessor 20 controls the audio encoder/decoder 270 and delivers sound data to the audio encoder/decoder 270. The third oscillation circuit 271 sends a driving signal to the audio encoder/decoder 270, the audio encoder/decoder 270 converts the sound data from the second microprocessor 20 to sound signals and delivers the sound signals to the third amplifier 272. In this embodiment, the third amplifier 272 is a differential amplifier. The third amplifier 272 magnifies the sound signal from the audio encoder/decoder 270 and delivers the signal magnified to the sounding device 273, then the sounding device 273 converts the sound signal to an output voice.

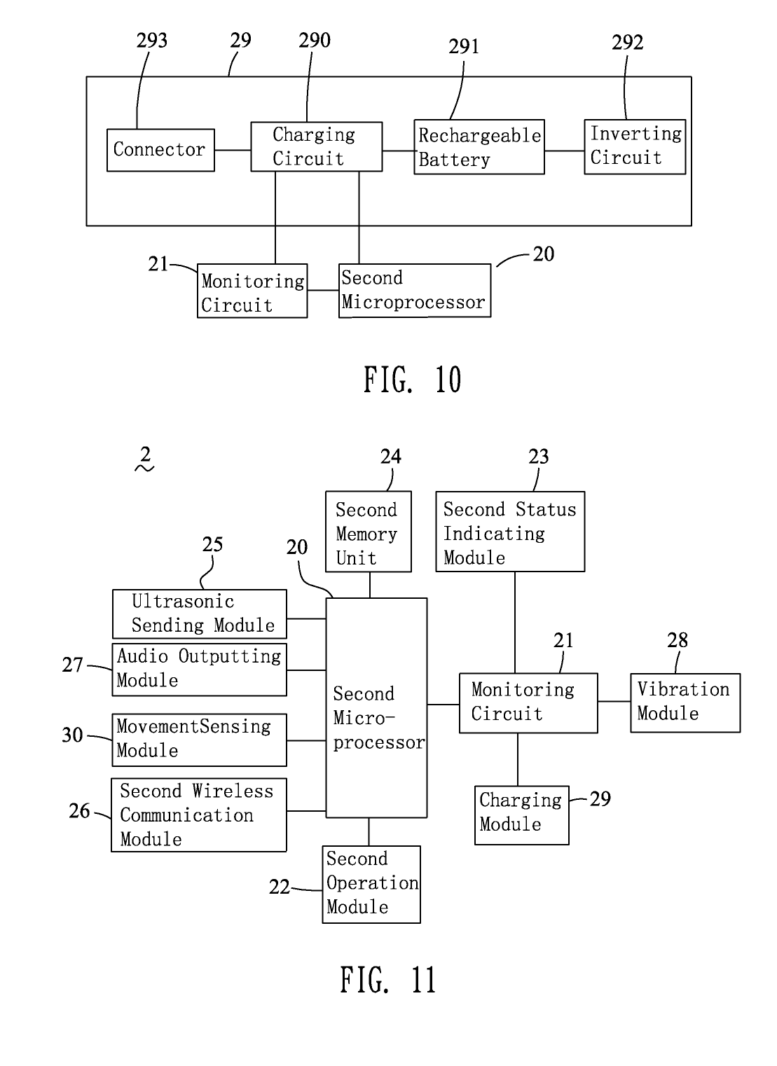

Please refer to FIG. 10, the charging module 29 has a charging circuit 290, a rechargeable battery 291, an inverting circuit 292 and a connector 293. The charging circuit 290 connects the rechargeable battery 291, the connector 293, the second microprocessor 20 and a monitoring circuit 21. The rechargeable battery 291 connects the inverting circuit 292. The charging circuit 290 connects an outer power via the connector 293 and can charge up the rechargeable battery 291. The inverting circuit 292 inverts the voltage of the rechargeable battery 291 to a working voltage of the wireless controller 2, such as 1.8 v, 3.3 v or 12 v, etc.

In this embodiment, the connector 293 is a USB connector. The charging circuit 290 can provide a steady current to the rechargeable battery 291, the second microprocessor 20 can decide whether the rechargeable battery 291 is recharged, the monitoring circuit 21 can monitor parameters of the rechargeable battery 291 such as the temperature, the voltage and the current, etc.

Referring to FIG. 11, the wireless controller 2 further comprises a movement sensing module 30, the movement sensing module 30 connects the second microprocessor 20. The movement sensing module 30 can detect the movement speed and the acceleration of the wireless controller 2, and delivers the data about the movement speed and the acceleration into the second microprocessor 20. The second wireless communication module 26 converts the data about the movement speed and the acceleration into wireless signals and delivers the wireless signals into the main apparatus 1.

The first wireless communication module 17 receives the wireless signal and converts the wireless signal into data about the movement speed and the acceleration, and delivers the data to the first microprocessor 10. The first microprocessor 10 calculates the time difference according to the received ultrasonic signals, and generates a coordinate about the wireless controller 2.

As above description, the interactive game system 100 can send out ultrasonic signals via the wireless controller 2, and the main apparatus 1 receives the ultrasonic signals and calculates the coordinate of the wireless controller 2 to ascertain the location of the wireless controller 2. The controlling signals and data are delivered between the main apparatus 1 and the wireless controller 2 via the first wireless communication module 17 and the second wireless communication module 26. The movement sensing module 30 detects the information about the movement speed and the acceleration of the wireless controller 2, and delivers the information to the main apparatus 1, so the main apparatus 1 can calculate the coordinate about the wireless controller 2 exactly.

Two embodiments of the present invention have been discussed in detail. However, those embodiments are merely some specific examples for clarifying the technical contents of the present invention, and the present invention is not to be construed in a restricted sense as limited to those specific examples. Thus, the spirit and scope of the present invention are limited only by the appended claims.

What is claimed is:

1. An interactive game system, comprising:
a main apparatus having
a plurality of ultrasonic receiving modules which can receive ultrasonic signals and send detecting signals,
a first microprocessor connecting the three ultrasonic receiving modules and receiving the detecting signals from the ultrasonic receiving modules to process a coordinate,
a first memory unit connecting the first microprocessor and storing data which produced by the first microprocessor,
a first wireless communication module connecting the first microprocessor, sending/receiving controlling signals and data between the first wireless communication module and the first microprocessor, the first wireless communication module converting the controlling signals and data into wireless signals, and
a USB module connecting the first microprocessor; and
a wireless controller having
an ultrasonic sending module sending ultrasonic signals into the main apparatus,
a second microprocessor connecting and controlling the ultrasonic sending module,
a second memory unit connecting the second microprocessor and storing the data from the second microprocessor,
a second wireless communication module connecting the second microprocessor, sending/receiving controlling signals and data between the second wireless communication module and the second microprocessor, the second wireless communication module converting the controlling signals and data into wireless signals,
a charging module storing electronic energy and providing to the wireless controller, and
a monitoring circuit connecting the second microprocessor and the charging module, detecting the state of the charging module according to the controlling data from the second microprocessor.

2. The interactive game system as claimed in claim 1, further comprising a first operation module connecting the first microprocessor, the first operation module detecting the press state of the first microprocessor and producing controlling signal.

3. The interactive game system as claimed in claim 2, further comprising a first status indicating module connecting the first microprocessor, the first status indicating module capable of displaying the status of the main apparatus.

4. The interactive game system as claimed in claim 1, wherein each of the ultrasonic receiving modules has an ultrasonic receiving apparatus, a first amplification circuit and a detecting circuit respectively, the first amplification circuit connects the ultrasonic receiving apparatus and the detecting circuit respectively, the first amplification circuit is used to amplify the ultrasonic signal from the ultrasonic receiving apparatus and deliver the signal into the detecting circuit, the detecting circuit connects the first microprocessor, filters and converts the signals from the first amplification circuit into detecting signals.

5. The interactive game system as claimed in claim 3, further comprising a second operation module connecting the second microprocessor, the second microprocessor detecting the press state of the second operation module and emitting controlling signals.

6. The interactive game system as claimed in claim 5, further comprising an audio outputting module connecting the second microprocessor and controlled by the second microprocessor.

7. The interactive game system as claimed in claim 6, further comprising a vibration module connecting the monitoring circuit, the monitoring circuit controlling the quake of the vibration according to the controlling signal of the second microprocessor.

8. The interactive game system as claimed in claim 7, further comprising a second status indicating module connecting the monitoring circuit, the monitoring circuit controlling the second status indicating module to display the state of the wireless controller according to the controlling signals from the second microprocessor.

9. The interactive game system as claimed in claim 1, wherein the ultrasonic sending module has a signal generator circuit, a second amplification circuit and an ultrasonic sending apparatus, the signal generator circuit connects the second microprocessor and the second amplification circuit respectively, and the signal generator circuit delivers the ultrasonic signal from the second microprocessor into the second amplification circuit, the second amplification circuit amplifies the ultrasonic signal and then outputs the ultrasonic signal by the ultrasonic sending apparatus.

10. The interactive game system as claimed in claim 8, further comprising a movement sensing module connecting the second microprocessor, the movement sensing module detecting the movement speed and the acceleration of the wireless controller, and delivering the data about the movement speed and the acceleration into the second microprocessor, the second wireless communication module converting the data about the movement speed and the acceleration into wireless signals and delivering the wireless signals into the main apparatus, the main apparatus calculating the detecting signals from the ultrasonic receiving modules and the data about the movement speed and the acceleration, then detecting the location of the main apparatus.
